(19) United States
(12) Patent Application Publication
(10) Pub. No.: US 2014/0247699 A1
(43) Pub. Date: Sep. 4, 2014

(54) Wearable Device with Moon Phase Display

(71) Applicant: TIMEX GROUP USA, INC., Middlebury, CT (US)

(72) Inventors: BORIS SEMBRITZKI, Karlsruhe (DE); SIEGFRIED GRAU, Pforzheim (DE)

(73) Assignee: Timex Group USA, Inc., Middlebury, CT (US)

(21) Appl. No.: 13/782,047

(22) Filed: Mar. 1, 2013

(51) Int. Cl. G04B 19/26

(52) U.S. Cl. CPC G04B 19/268
USPC 368/15

(57) ABSTRACT

A wearable device comprising a display arrangement for displaying moon phases. The image of the one or more moons is provided in the dial and a rotating member is provided above the dial to provide images of a full, waning, new and waxing moon. The device provides for both bi-directional and uni-directional rotation of the rotating member. The device can simultaneously or selectively display moon phases consistent with views from the northern hemisphere and/or southern hemisphere.

### BACKGROUND OF THE INVENTION

The present invention is directed generally to wearable devices that display moon phases, and in particular, to an improved moon phase display arrangement and methodology that provides for among other things, increased display options and functionality. In a particularly desirable embodiment, the wearable device is a timepiece, but it will be understood from the disclosure herein that the invention is not so limiting. Lunar or moon phase displays (both intended herein to have the same meaning) have been incorporated into wearable devices, and timepieces in particular, for many years. Examples of such third party designs can be found in such references as U.S. Pat. Nos. 6,928,032 and 7,609,587, U.S. Pub. Nos. 2011/0292767 and 2011/0310707, and JP 60-060580 and EP 1 445 672. However, it is believed that each of the foregoing constructions have perceived deficiencies. For example, many of prior art examples require extra gearing and/or are limited in the display options that can be provided thereby.

One additional known commercial product incorporating a moon phase display is provided under the Jaquet-Droz brand and provided in the timepiece sold under the designation “the eclipse ivory enamel.” However, this design also has several perceived deficiencies. For example, this construction has limited rotational abilities for the indicator, and thus it must move backwards (i.e. in the opposite CW or CCW direction) after the end of complete moon phase cycle display. In addition, this known design is further limited by its inability to display both the northern and southern hemispheres simultaneously.

Thus, an improved moon phase display is desirable. For example, it is desired to provide a moon phase display in which the moon is printed or otherwise adhered to a stationary dial and where a rotating member is provided above the dial, such that it is not required to rotate the indicator backwards to return to a starting position and further, that the rotation thereof can provide fur the images of the moon phases as seen in the northern hemisphere and/or the southern hemisphere, and in addition, can provide for additional display advantages.

Other objectives and features that address deficiencies in the prior art are also provided as disclosed herein.

### SUMMARY AND OBJECTIVES OF THE INVENTION

It is thus an objective of the present invention to overcome the perceived deficiencies in the prior art.

Specifically, it is an objective of the present invention to provide a wearable device with a moon phase display in which there is a minimum number of rotating parts. For example, it would be advantageous to provide such a wearable device in which the moon images(s) are stationary and the rotating part is located above the dial to provide the visible moon phases.

It is yet a further objective of the present invention to provide a wearable device in which the moon phases for the northern hemisphere and/or the southern hemisphere could be simultaneously or selectively displayed.

It is yet another objective of the present invention to provide a wearable device in which a controller and other components can be easily modified for such moon phase displays, including without additional and complicated gearing arrangements.

It is still another objective of the present invention to provide a moon phase display arrangement in which there is a possibility of providing a rotating member that rotates at a continuous speed, and is not required to move backwards to a prior starting position.

It is yet a further objective to be able to use a uni-directional motor for such moon phase displays if desired, and not be limited to a bi-directional motor.

Still a further objective of the present invention is to provide methodologies for carrying out and/or facilitating the foregoing.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

Therefore, and generally speaking, in accordance with a first preferred embodiment, the present invention is directed to a wearable device comprising a display arrangement for displaying moon phases, wherein the display arrangement comprises a dial having a front side and a back side; at least a first image of a moon on the front side of the dial, a rotatable member mounted above the dial, the rotatable member comprising at least a first hand and a second hand, wherein the first hand and the second hand are at least essentially rounded and at least essentially non-transparent; wherein from a first starting position, a rotation of the rotatable member in a first direction causes the moon image to appear to be waning due to the progressive blocking of the moon image by the first hand and then waxing due to the subsequent progressive unblocking of the moon image by the first hand, and after the rotatable member rotates in the first direction so that the moon image is at least essentially fully unblocked by the first hand, the second hand is positioned essentially where the first hand was positioned when the rotatable member was in the first starting position.

In accordance with a second preferred embodiment, the wearable device of the present invention comprises a display arrangement for displaying moon phases, wherein the display arrangement comprises a dial having a front side and a back side; at least a first image of a moon on the front side of the dial and a second image of a moon on the front side of the dial, wherein the second moon image is spaced from the first moon image; a rotatable member mounted above the dial, the rotatable member comprising at least a hand, the first hand being at least essentially rounded and at least essentially non-transparent; selecting means for selecting whether to display moon phases using the first moon image or the second moon image, wherein in response to the selecting, the controller causes the rotatable member to be positioned in one of a plurality of starting positions, wherein from a first starting position, a rotation of the rotatable member in a first direction causes the moon images, which are selected to be displayed using the first moon image or the second moon image, to appear to be waning due to the progressive blocking of the selected first or second moon image by the hand and then waxing due to the subsequent progressive unblocking of the selected moon image by the hand; wherein selecting to display moon phases using the first moon image will display moon phase images consistent with views from the northern hemisphere and selecting to display moon phases using the second moon image will display moon phase images consistent with views from the southern hemisphere.

In accordance with a third preferred embodiment of the present invention, the wearable device comprises a display arrangement for displaying moon phases, wherein the display arrangement comprises a dial having a front side and a back side; at least a first image of a moon on the front side of the dial and a second image of a moon on the front side of the dial; a rotatable member mounted above the dial, the rotatable member comprising at least a first hand and a second hand, wherein the first and second hands are each at least essentially rounded and at least essentially non-transparent; wherein from the first starting position, a rotation of the rotatable member in a first direction causes the first moon image to appear to be waning due to the progressive blocking of the first moon image by the first hand simultaneously with causing the second moon image to appear to be waning due to the identical progressive blocking of the second moon image by the second hand, and thereafter, further causing the first moon image to appear to be waxing due to the subsequent progressive unblocking of the first moon image by the first hand simultaneously with causing the second moon image to appear to be waxing due to the identical progressive unblocking of the second moon image by the second hand; whereby the first moon images are representative of moon phases viewed from the northern hemisphere and the second moon images are representative of moon phases viewed from the southern hemisphere.

In yet a fourth preferred embodiment of the present invention, the wearable device comprises a display arrangement for displaying moon phases, wherein the display arrangement comprises a dial having a front side and a back side; at least a first image of a moon on the front side of the dial, a rotatable member mounted above the dial, the rotatable member comprising at least a first hand, the first hand being at least essentially rounded and at least essentially non-transparent; wherein from a first starting position, a rotation of the rotatable member in a first direction and at a first rate of rotation causes the moon image to appear to be waning due to the progressive blocking of the moon image by the first hand and then waxing due to the subsequent progressive unblocking of the moon image by the first hand; wherein from the first starting position for the rotatable member, the moon image is filly unblocked by the first hand, and wherein the wearable device comprises a controller for operatively causing the rotatable member to rotate in the first direction so as to cause the moon image to (i) appear to be waning due to the progressive blocking of the moon image by the first hand, (ii) next be at least essentially fully blocked by the first hand thereby providing a moon phase representative of a new moon, and (iii) then appear to be waxing due to the unblocking of the moon image by the first hand, wherein the rotatable member rotates in the first direction until the moon image is at least essentially fully unblocked by the first hand; and wherein after the rotatable member has rotated in the first direction so that the moon image is at least essentially fully unblocked by the first hand, the controller causes the rotatable member to continue to rotate in the first direction until the rotatable member is in the first starting position.

In a preferred embodiment, the wearable device is a timepiece in the form of a wristwatch.

### BRIEF DESCRIPTION

The above set forth and other features of the invention are made more apparent in the ensuing Description of the Preferred Embodiments when read in conjunction with the attached Drawings, wherein:

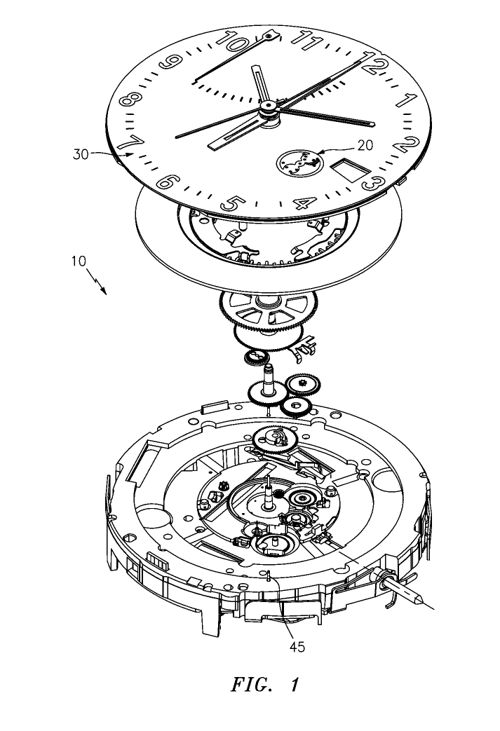

FIG. 1 is a perspective view of a wearable device in the form of a timepiece, constructed in accordance with the present invention;

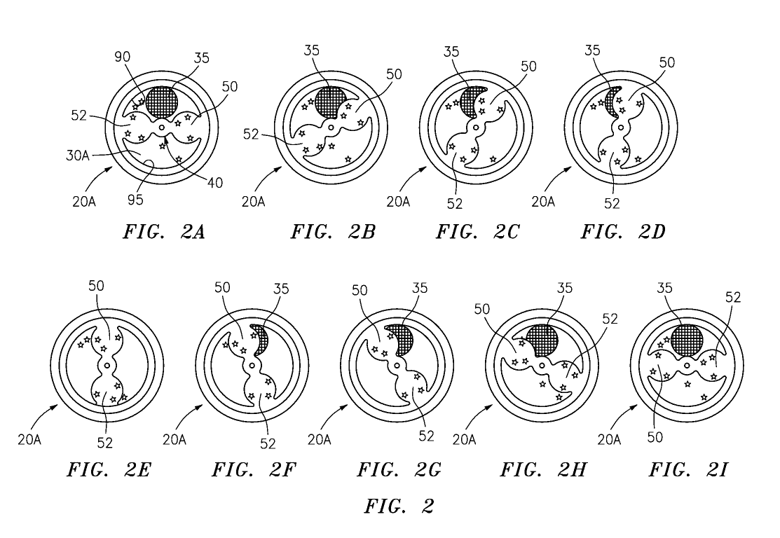

FIG. 2 collectively refers to a set of sub-figures, namely FIGS. 2A-2I, each of which represent a moon phase display on a display arrangement for displaying moon phases in accordance with a first embodiment of the present invention;

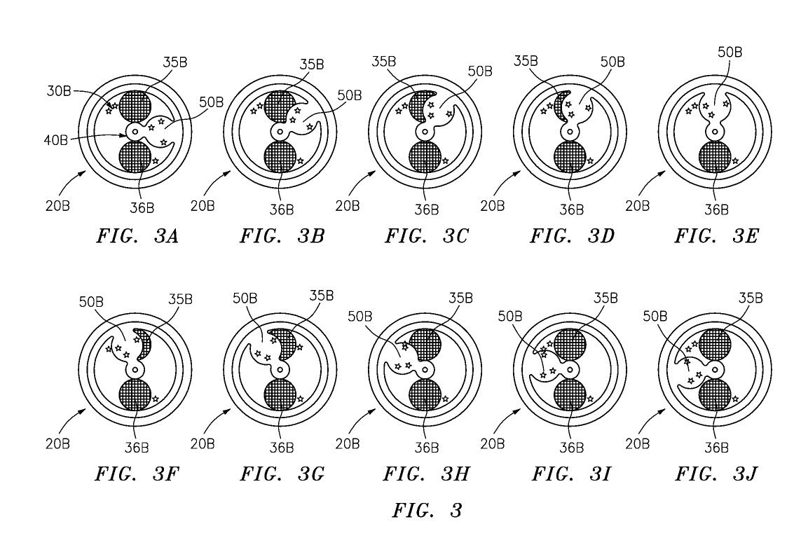

FIG. 3 collectively refers to a set of sub-figures, namely FIGS. 3A-3J, each of which represent a moon phase display on a display arrangement for displaying moon phases in accordance with a second embodiment of the present invention;

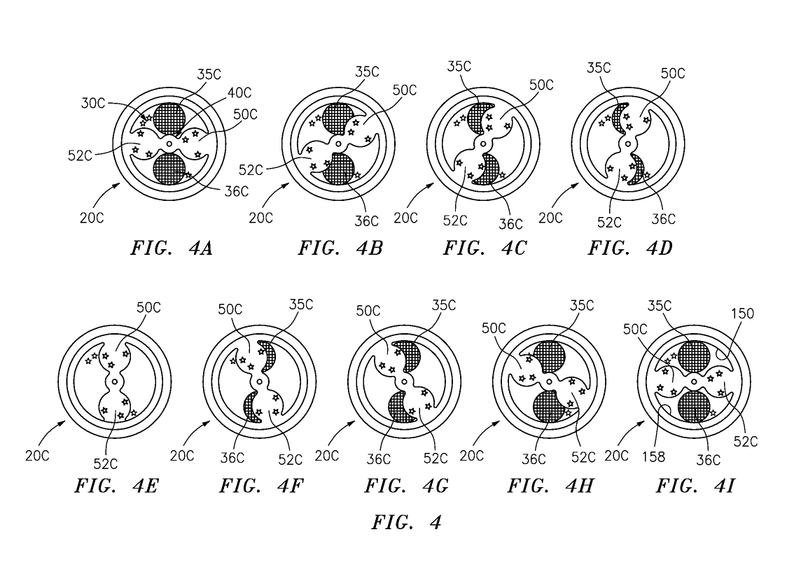

FIG. 4 collectively refers to a set of sub-figures, namely FIGS. 4A-4I, each of which represent a moon phase display on a display arrangement for displaying moon phases in accordance with a third embodiment of the present invention;

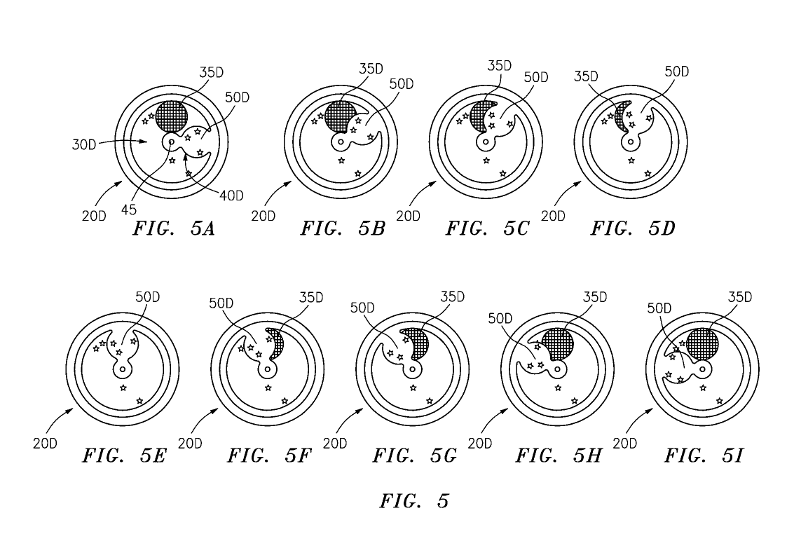

FIG. 5 collectively refers to a set of sub-figures, namely FIGS. 5A-5I, each of which represent a moon phase display on a display arrangement for displaying moon phases in accordance with a fourth embodiment of the present invention;

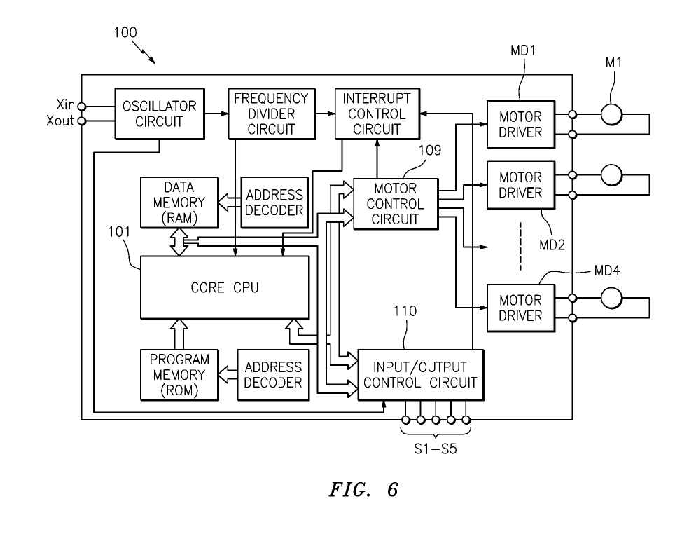

FIG. 6 is a block diagram of a controller, constructed in accordance with a preferred embodiment, for carrying out the objectives and advantages of the present invention; and

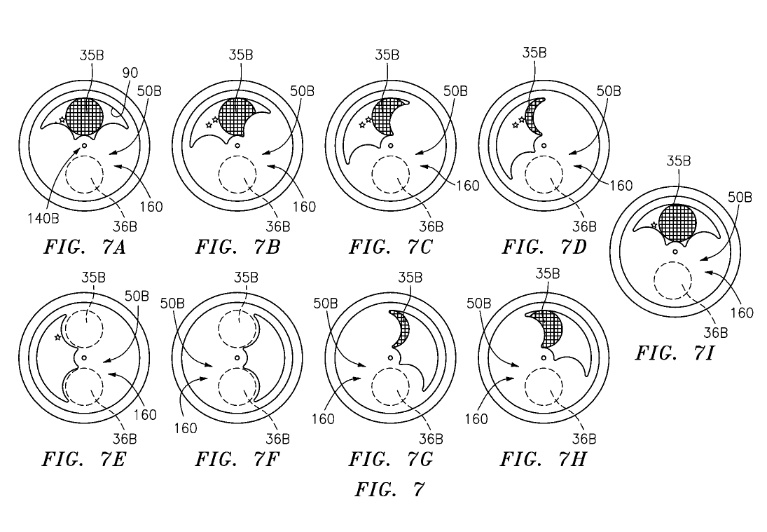

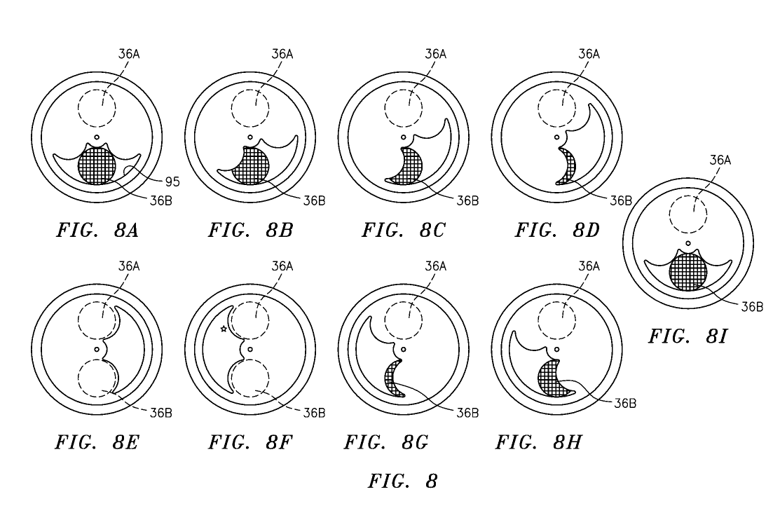

FIGS. 7 & 8 collectively and respectively refer to sets of sub-figures, namely FIGS. 7A-7I and 8A-8I, respectively, each of which represent a moon phase display on a display arrangement for displaying moon phases in accordance with alternative embodiments of the aforementioned second embodiment of the present invention.

Identical reference numerals in the figures are intended to indicate like parts, although not every feature in every figure may be called out with a reference numeral.

### DETAILED DESCRIPTION OF THE PREFERRED EMBODIMENTS

Reference is first made to FIG. 1 which discloses a wearable device, generally indicated at 10, constructed in accordance with the present invention. In a preferred embodiment, wearable device 10 is a timepiece, and a wristwatch in particular, but those skilled in the art will realize the invention is not so limiting, since the present invention can be incorporated into a wide range of products, some of which are disclosed in U.S. Pat. No. 7,113,450, the subject matter of which for all purposes being incorporated by reference as if fully set forth herein.

In all of the preferred embodiments of the present invention, wearable device 10 comprises a display arrangement for displaying moon phases. The display arrangement illustrated in FIG. 1, and generally indicated by reference number 20, is illustrative of just one of many possible positions (and constructions) of the display arrangement 20 about a dial, itself generally indicated at 30. To be sure, the position of display arrangement 20 about dial 30 is one of a design choice by those skilled in the art. Furthermore, the display arrangement illustrated in FIG. 1 is intended to be an example and represent the many other display arrangements that are constructed in accordance with the present invention and disclosed herein. Therefore, it should be understood that any of the display arrangements disclosed herein can be incorporated into the wearable device of the present invention.

Thus, reference is next made to the display arrangement, generally indicated at 20A, of FIG. 2, wherein a first embodiment of the present invention is illustrated. In the embodiment of FIG. 2, display arrangement 20A comprises a dial, generally indicated at 30A, having a front side and a back side. Display arrangement 20A further comprises at least a first image of a moon, indicated by reference number 35, on the front side of the dial 30. A rotatable member, generally indicated at 40, is also provided, and is mounted above the dial 30, preferably on a stem 45 (FIG. 1). Stem 45 is coupled to a gearing arrangement, comprising one or more gears, which itself is preferably coupled to a motor, such as a stepper motor. Examples of rotatable members and other indicators and how they are coupled through one or more gears to a stepper motor is disclosed with numerous examples in the aforementioned U.S. Pat. No. 7,113,450 and well known in the art. An exemplary motor M1 for rotating the rotating members of the disclosed embodiments herein is illustrated in FIG. 6. In the embodiment of FIG. 2, the rotatable member 40 comprises at least a first hand 50 and at least a second hand 52, with preferably both the first and second hands 50, 52 being at least essentially rounded and at least essentially non-transparent. Use of the term “at least essentially” means that of course perfectly rounded or completely opaque is not needed to carry out and the objectives of the invention. In fact, “at least essentially rounded” is intended to indicate that the shape of the moon is most accurately depicted if the shape of the moon image covering portion (e.g. hand 50 or hand 52) is round or at least close to round. Similarly, to accurately depict a moon that is difficult to see (e.g. a “new” moon), it is preferable that hand 50 and/or hand 52 hides the moon image when hand 50 or hand 52 is covering the moon image. Therefore, although completely opaque and a sufficiently large area to fully cover the moon image is desired, some degree of transparency would not thwart the objectives of the present invention.

In addition, the rotatable member of FIG. 2, as with the similarly shaped rotatable members of FIGS. 4, 7 and 8 can also be perceived as having two (2) windows, exemplary illustrated as windows 90, 95 (see FIG. 2A) although not every window in all the figures are so labeled.

As further illustrated in FIG. 2 generally, FIG. 2A illustrates rotatable member 40 in a first preferable starting position, where hand 50 is positioned slightly to the right of and below the moon image 35, while hand 52 is positioned slightly to the left of and below the moon image 35. Here, and with reference to hand 50 for exemplary purposes, a rotation of the rotatable member 40 in a first (e.g. counterclockwise) direction causes the moon image 35 to appear to be waning due to the progressive blocking (e.g. see FIGS. 2B, 2C, 2D) of the moon image 35 by the hand 50 and then waxing due to the subsequent progressive unblocking (e.g. see FIGS. 2F, 2G, 2H) of the moon image 35 by the hand 50. FIG. 2E illustrates a preferably fully blocked moon image by hand 50. However, as mentioned above, if hand 50 is not exactly round or 100% opaque or perfectly aligned or centered, the invention will provide that moon image 35 is at least essentially blocked by hand 50. This FIG. 2E corresponds to a “new” moon. FIG. 2I illustrates the subsequent “full” moon.

As disclosed more fully below, the wearable device comprises at least a controller for rotating the rotatable member 40 in the counterclockwise direction so as to cause the moon image 35 to (i) appear to be waning (e.g. FIGS. 2B, 2C, 2D) due to the progressive blocking of the moon image 35 by the hand 50, (ii) next be at least essentially fully blocked (e.g. FIG. 2E) by the hand 50 thereby providing a moon phase representative of a “new” moon, and (iii) then appear to be waxing (e.g. FIGS. 2F, 2G, 2H) due to the unblocking of the moon image 35 by the hand 50. Again, in a counterclockwise direction, the rotatable member 40 rotates until the moon image 35 is a full moon and at least essentially fully unblocked by the hand 50 (e.g. FIG. 2I).

Advantageously, after the rotatable member 40 rotates in the e.g. counterclockwise direction, such that the moon image is at least essentially fully unblocked by the first hand (e.g. FIG. 2I), the second hand 52 is then already positioned at least essentially where the hand 50 was positioned when the rotatable member was in the first starting position (e.g. FIG. 2A). Thus, the embodiment of FIG. 2 has the advantage of not requiring the rotating member 40 to rotate backward or forward after the “full” moon of FIG. 2I to be ready for the next moon phase cycle, thus being at least one significant advantage over the cited prior art above.

Reference is now made to FIG. 3, for yet another preferred embodiment of the present invention. In this embodiment, the display arrangement, generally indicated at 20B, also comprises a dial, generally indicated at 3013, having a front side and a back side. Display arrangement 20B also comprises at least a first image of a moon, indicated by reference number 35B as well as an image of a second moon, indicated by reference number 36B, on the front side of the dial 30B. In this embodiment, the rotatable member is generally indicated at 40B and also mounted above the dial 30B and preferably on stem 45, also similar to the aforementioned embodiment. In the embodiment of FIG. 3, the rotatable member 40B comprises a first hand 50B, which is again at least essentially rounded and at least essentially non-transparent for the same reasons noted above.

This embodiment of FIG. 3 operates similarly to the embodiment discussed above and illustrated in FIGS. 2A-2I, but has the additional feature of being able to provide a display of the moon phases in both the northern hemisphere and the southern hemisphere. For example, the moon phases as seen in the northern hemisphere would be depicted as first hand 50B moves over moon image 35B as discussed above with reference to FIG. 2, while the moon phases as seen in the southern hemisphere would be depicted as first hand 50B moves over moon image 36B. In this latter case of depicting the southern hemisphere moon displays, the starting position for rotatable member 40B is depicted in FIG. 3J, and the successive rotation of hand 50B is conveniently discussed below with regard to FIG. 4, hand 52C and moon image 36C.

In yet another feature of this FIG. 3 embodiment, selecting means, in the form of a pusher and other associated software and hardware as discussed below in FIG. 6, may be provided for selecting whether to display moon phases using the first moon image 35B (e.g. for the northern hemisphere) or the second moon image 36B (e.g. for the southern hemisphere). That is, in response to the selecting, the controller can cause the rotatable member 40B to be positioned in one of a plurality of starting positions. For example, selecting to display moon phases using the first moon image 35B will display moon phase images consistent with views from the northern hemisphere and selecting to display moon phases using the second moon image 36B will display moon phase images consistent with views from the southern hemisphere.

In the northern hemisphere display, after the rotatable member has rotated such that the moon image 35B is at least essentially fully unblocked by the first hand 50B (e.g. FIG. 3I), a controller as more fully disclosed below causes the rotatable member to rotate (preferably at a rate faster than the rate of rotation of first hand 50B as it goes through its natural progressions from its FIG. 3A position to its FIG. 3I position) in the CW direction back to the first starting position (FIG. 3A) or in the continuing CCW direction until the rotatable member is back in its starting position 3A. A corresponding and similar fast rotation occurs during the displaying of the southern hemisphere moon images.

As also depicted in the figures of FIG. 3, the first moon image 35B is located about a top half of the dial 30B and wherein the second moon image 36B is located about a bottom half of the dial 30B.

Reference is now made to FIG. 7 for an alternative preferred embodiment of the two moon image design of FIG. 3, First, it can be seen that in this FIG. 7 construction, the dial, first image of the moon and second image of the moon is constructed the same way as in the FIG. 3 embodiment. The difference in this FIG. 7 embodiment is that the rotatable member, generally indicated at 140B, has one of the “windows” (e.g. window 95, see FIG. 2A) essentially opaque, thus leaving only one “open window,” i.e. window 90. In this way, hand 50B in FIG. 7 is larger and includes a general cover, which is shown generally by reference number 160 (also shown by the dotted lines in FIG. 7B). Thus, for purposes of understanding the claims, reference to the feature of a “hand” in this claimed embodiment is also intended to be broad enough to include the cover 160 as discussed and illustrated in FIG. 7.

Although this FIG. 7 embodiment operates similar to the FIG. 3 embodiment, the FIG. 7 embodiment ensures that the wearer does not undesirably (should the wearer not want to) see the image of the moon for the hemisphere that the wearer has not selected.

For example, and similar to the FIG. 3 embodiment, if the user selects to display moon phases using the first moon image 35B (e.g. for the northern hemisphere), hand 50B, which now includes the general “cover” 160, will thereafter be blocking second moon image 36B all the while where the rotatable member rotates as shown in FIGS. 7A-7I, with one possible momentary exception, namely, which is that in this FIG. 7 embodiment, a fast rotation (e.g. within a few seconds) is needed from the “new” moon position of FIG. 7E to the position of the rotatable member of FIG. 7F in order to be timely ready to begin displaying of the waxing moon images. This fast rotation can be in either the clockwise (CW) or counterclockwise (CCW) direction. In this example, the rotatable member as constructed in FIG. 7 will display moon phase images consistent with views from the northern hemisphere, the second moon image is blocked thereby not causing any confusion or unwanted display of another moon image.

FIG. 8 illustrates an embodiment very similar to the FIG. 7 design, except that it is applicable to the display of moon images for the southern hemisphere, which, in the FIG. 8 embodiment, assumes that the viewable moon image in the figures is moon image 36B. Other than that, this FIG. 8 embodiment is very similar to the FIG. 7 embodiment.

Reference is now made to FIG. 4, which illustrates yet another preferred embodiment of the present invention. In this embodiment, the display arrangement, generally indicated at 20C, also comprises a dial, generally indicated at 30C, having a front side and a back side. Display arrangement 20C also comprises at least a first image of a moon, indicated by reference number 35C as well as an image of a second moon, indicated by reference number 36C, on the front side of the dial 30C. In this embodiment, the rotatable member is generally indicated at 40C and also mounted above the dial 30C and preferably on stem 45, also similar to the aforementioned embodiments. The rotatable member 40C comprises at least a first hand 50C and at least a second hand 52C, with preferably both the first and second hands 50C, 52C being at least essentially rounded and at least essentially non-transparent for the same reasons noted above.

The embodiment of FIG. 4 operates similarly to the embodiments discussed above and in fact combines many of the features thereof, and yet has the additional feature of being able to provide the simultaneous appearance of the moon phases in the northern hemisphere and the southern hemisphere. For example, the moon phases as seen in the northern hemisphere would be depicted as first hand 50C moves over moon image 35C as discussed above, while the moon phases as seen in the southern hemisphere would be depicted as second hand 52C moves over moon image 36C.

In this latter example of depicting the southern hemisphere moon displays, the starting position for rotatable member 40C is also depicted in FIG. 4A.

Specifically, hand 52C starts off being positioned slightly to the left and above (e.g. clockwise from) the moon image 36C. Here, a rotation of the rotatable member 40C in a first (e.g. counterclockwise) direction causes the moon image 36C to appear to be waning due to the progressive blocking (e.g. see FIGS. 4B, 4C, 4D) of the moon image 36C by the second hand 52C and then waxing due to the subsequent progressive unblocking (e.g. see FIGS. 4F, 4G, 4H) of the moon image 36C by the second hand 52C. The moon images for the southern hemisphere are fully applicable to the embodiment disclosed above with reference to FIG. 3.

Here again, FIG. 4E illustrates a preferably fully blocked moon image 36C and represents the “new” moon in both the northern and southern hemispheres. To be sure, for the northern hemisphere, first hand 50C operates as set forth above in the previous disclosed embodiments. FIG. 4I illustrates the subsequent “full” moon fur both the northern and southern hemispheres.

The controller referenced above and discussed below controls the rotation of all the rotatable members disclosed herein. In this way, the controller in all the embodiments causes each of the disclosed rotatable members to rotate so that the respective moon image(s) appear to be waning due to the progressive blocking of the moon image(s) by one of the first and/or second hands, next be at least essentially fully blocked by the respective hand(s) thereby providing a moon phase representative of a “new” moon, and then appear to be waxing due to the unblocking of the moon image(s) by the respective first and/or second hand(s). Again, in the counterclockwise direction, each respective rotatable member in each embodiment rotates until the respective moon image is a “full” moon and at least essentially fully unblocked by the respective hand (e.g. FIGS. 2I, 3I and 4I).

An advantageous feature of the FIG. 4 embodiment is that the respective hands 50C, 52C need not additionally rotate after the “full” moon because each hand would already be in the appropriate starting positions for the next cycle of moon phases.

In this way with respect to this FIG. 4 embodiment, from a first starting position (e.g. FIG. 4A), a rotation of the rotatable member 40C in a first (e.g. counterclockwise) direction causes the first moon image 35C to appear to be waning due to the progressive blocking of the first moon image 35C by the first hand 50C (e.g. FIGS. 4B, 4C, 4D) simultaneously with causing the second moon image 36C to appear to be waning due to the identical progressive blocking of the second moon image 36C by the second hand 52C (e.g. also shown in FIGS. 4B, 4C, 4D), and thereafter, further causing the first moon image 35C to appear to be waxing due to the subsequent progressive unblocking of the first moon image 35C by the first hand 50C (e.g. FIGS. 4F, 4G, 4H) simultaneously with causing the second moon image 36C to appear to be waxing due to the identical progressive unblocking of the second moon image 36C by the second hand 52C (e.g. also shown in FIGS. 4F, 4G, 4H). In this way, the first moon images 35C are representative of moon phases viewed from the northern hemisphere and the second moon images 36C are representative of moon phases viewed from the southern hemisphere.

Here again, the first moon image 35C is located about a top half of the dial 30C and wherein the second moon image 36C is located about a bottom half of the dial 30C. Reference is next made to the preferred embodiment of the display arrangement, generally indicated at 20D, of FIG. 5. In the embodiment of FIG. 5, display arrangement 20D likewise comprises a dial 30D having a front side and a back side, but in this embodiment only one moon image, indicated by reference number 35D. A rotatable member, generally indicated at 40D is also provided and mounted and driven by a motor as in the aforementioned embodiments. Here, the rotatable member 40D comprises just one hand 50D, it too being at least essentially rounded and at least essentially non-transparent, as defined above.

Like the aforementioned embodiments, FIG. 5A illustrates rotatable member 40D in a first preferable starting position, where hand 50D is positioned slightly to the right of and below the moon image 35D. Here, a rotation of the rotatable member 40D in a first (e.g. counterclockwise) direction causes the moon image 35 to appear to be waning due to the progressive blocking (e.g. see FIGS. 5B, 5C, 5D) of the moon image 35D by the first hand 50D and then waxing due to the subsequent progressive unblocking (e.g. see FIGS. 5F, 5G, 5H) of the moon image 35D by the first hand 50D.

FIG. 5E illustrates a preferably fully blocked moon image by hand 50 corresponding to a “new” moon, while FIG. 5I illustrates the subsequent “full” moon.

The controller controls the rotation of the rotatable member 40D in the same manner as set forth above with respect to the aforementioned embodiments.

Here, with specific reference to the embodiment of FIG. 5, after the rotatable member 40D has rotated in the counterclockwise direction so that the moon image 35D is at least essentially fully unblocked by the first hand 50D (i.e. FIG. 5I), the controller is configured to (i) cause the rotation of the rotatable member 40 in the direction opposite the first direction (e.g. in the clockwise direction) and back to the first starting position (i.e. FIG. 5A) and/or (ii) cause the rotation of the rotatable member 40 to continue to rotate in the first (e.g. counterclockwise) direction until the rotatable member is back in the first starting position (i.e. FIG. 5A). A fast rotation (e.g. within a few seconds at most) from the position of FIG. 5I back to FIG. 5A is preferable,

That is, in this embodiment, from a first starting position, the rotatable member rotates in the first direction and at a first rate of rotation causing the moon image to appear to be waning due to the progressive blocking of the moon image by the first hand and then waxing due to the subsequent progressive unblocking of the moon image by the first hand, and after the rotatable member has rotated in the first direction so that the moon image is at least essentially fully unblocked by the first hand, the controller can cause the rotatable member to rotate at a rate faster than the first rate of rotation (i) in the direction opposite the first direction and back to the first starting position or (ii) in the first direction until the rotatable member is in the first starting position. This option can be factory set or may even be user selectable. If the embodiment is such that the rotatable member is to rotate in the direction opposite the first direction, the wearable device will comprise a bi-directional motor to carry out said rotating.

It can be seen that the rotation of the rotatable member 40 to rotate in either the clockwise or counterclockwise direction from the position in FIG. 5I to the position in FIG. 5A is approximately 180°. That is, after the full moon, rotatable member 40D will most likely rotate either in the clockwise direction by 180° or a bit less, or in the counterclockwise direction by 180° or a bit more in order to return to the starting position.

The wearable device in accordance with the present invention will be provided with sufficient software routines and data sufficient to maintain information about the moon phases in both the northern and southern hemisphere and thus be able to maintain the proper moon phase displays independent of the hour and minute hands/wheels. This provides for a very flexible user friendly and relatively easy to manufacture moon phase display assembly for a wearable device. As also alluded to above, wearable device 10 will further comprise at least a controller for carrying out all the functionality set forth and/or contemplated herein, along with at least one actuation mechanism, preferably in the form of a stepping motor, and one or more gears rotatably engaged with the actuation mechanism, wherein actuation of the actuation mechanism causes the rotation of the one or more gears, which in turn appropriately, accurately and incrementally rotates the rotatable members disclosed herein. Reference may be had to the aforementioned U.S. Pat. No. 7,113,450, the subject matter of which is incorporated by reference herein, for a more in depth illustration and description of a stepper motor that can be used to rotate each of the rotatable members disclosed herein. As would he understood in the art, the specific location of the stepper motor is one of design choice and dictated by constraints such as spacing, power and torque requirements and the desired positioning of the moon phase display. The construction of an appropriate gear train is well within the purview of one ordinarily skilled in the art.

Details of a suitable controller to carry out the present invention is illustrated in FIG. 6 and generally indicated at 100. FIG. 6 also illustrates the interface connections to a motor e.g. M1 that may be used to rotate the rotatable member(s) of the present invention.

One or more of the switches S1-S5 can be used in combination with other hardware and software, as needed and disclosed herein, as the appropriate means to, for example, cause the rotating member to return to its starting position by rotating in an opposite (e.g. clockwise) direction or to continue in the clockwise direction, all as disclosed above in connection with the embodiments of FIGS. 3 and 5. In addition, such pushers and other hardware and software herein, as needed and/or appropriate, can be used to select, for example, in the FIG. 3 embodiment, whether to use hand 50B to provide for the moon phases of the northern or southern hemisphere. The switches are intended to generically indicate both side/top mounted pushers, rotatable crowns, or the like and thus respond to the actuation (i.e. pulling and/or pushing) action thereof.

For example, motor control circuit 109, may receive a commanded “next number of pulses” from CPU core 101 and generate the pulsed and phased signals necessary to move a desired motor (e.g. M1) a desired amount and in a desired direction so as to rotate each of the rotatable members disclosed herein. Pulse outputs of motor control circuit 109 may be buffered by the one or more motor drivers MD1-MD4 and applied to the respective motors (e.g. M1). Other motors are omitted herein for brevity, but of course may be used if multiple display indicators (e.g. time and date) are used with the invention, since only a single motor is actually required to carry out the functionality of the present moon phase display arrangement invention. An input/output control circuit 110 can control pushbutton switches S1-S5 and provides such signaling information to CPU 101. The use of the pushers and/or the crown can also effectuate a change in operating modes or display options as disclosed above and would be understood by one skilled in the art. To be sure however, a suitable controller for the present invention can likewise be found in the aforementioned '450 patent, wherein such a controller provides the proper and accurate controlling, positioning and rotation of the first and/or second hands disclosed herein, and so the subject matter related thereto is incorporated by reference herein.

That is, via coding and software programming, controller 100 need not “know” the specific positioning of the respective rotatable member(s) in the respective embodiments. That is, the controller need only be programmed to accurately move the indicator at the correct speed in line with the moon phases in the sky. Such programming would be understood by those skilled in the art. In the case where the rotatable member gets out of a correct position, the user need only move the indicator, such as by usage of a pusher or the like, so as to move i.e. reposition) the rotatable member to its correct position.

To be sure, and as would be understood in the art, stepper motor Ml itself comprises a rotor, and is operatively coupled to the controller, wherein the stepper motor steps in at least one of a clockwise and counterclockwise direction in predefined increments in response to commands from the controller, wherein the rotor of the stepper motor is operatively coupled to the rotatable members disclosed herein, and wherein the rotation of the rotor causes the rotation of the rotatable member in the clockwise and/or counterclockwise directions and in the predefined increments. In the preferred embodiments, the motor(s) are bi-directional stepper motors as appropriate, thus being able to rotate in either direction, and the construction of acceptable stepper motors to functionally operate in this manner are widely available and well within the understanding of those skilled in the art.

Lastly, although the preferred embodiments provide that controller 100 is highly integrated wherein all timing and display functionality is controlled in controller 100, alternate embodiments could separate the timekeeping functions from those processes to carry out the present invention, as would be understood by one skilled in the art.

As should also be appreciated by one skilled in the art, the location, position and/or size of the rotatable member and display arrangement are merely dictated, for example, by the position of pinions and the position of the respective subassemblies and thus the illustrations herein are shown by example and not limitation. The gearing ratio to provide for the desirable display rotation or movement of the rotatable members herein would also be one of design choice depending on the requirements of the wearable device 10. Thus the number of wheels in any particular gearing assembly is one of design choice for the intended function and based upon a number of criterions known to the ordinary designer. Also, the functionality of the controller can be modified to accommodate the varying embodiments disclosed herein by software-programming techniques or differing controllers, both of which is well within the purview of the skilled artisan.

It can thus be seen that the present invention provides a wearable device with a moon phase display in which there is a minimum number of rotating parts. Still further, the present invention provides a wearable device in which the moon phases for the northern hemisphere and/or the southern hemisphere could be simultaneously or selectively displayed. Further, the present invention provides a moon phase display arrangement in which there is a possibility of providing a rotating. member that rotates at a continuous speed, and is not required to move backwards to a prior starting position. And still further, the present invention can utilize a unidirectional motor and still carry out the objectives disclosed herein.

It will thus be seen that the objects set forth above, among those made apparent from the preceding description, are efficiently attained and, since certain changes may be made in the above constructions without departing from the spirit and scope of the invention, it is intended that all matter contained in the above description or shown in the accompanying drawings shall be interpreted as illustrative and not in a limiting sense. For example, the moon images can be painted, glued, silk screened on or otherwise adhered to the dial. In addition, all of the foregoing can be carried out with the respective rotatable members being rotated in the clockwise direction if such images are desirable. In addition, the present invention further provides that only a uni-directional motor is needed, which adds to the flexibility of implementing the present invention. Still further, the examples above whereby the display sequence begins with a full moon is only by way of example and not limitation, as those skilled in the art will realize that any starting position of the rotating member is possible. Still further, the position of the moon images as set forth in the illustrations are by example only, and the present invention contemplates that the moon images may be positioned differently on the dial, thereby providing the moon phase display from differing hemisphere perspectives.

It should also be understood that the following claims are intended to cover all of the generic and specific features of the invention described herein and all statements of the scope of the invention that as a matter of language might fall therebetween.

What is claimed is:

1. A wearable device comprising a display arrangement for displaying moon phases, wherein the display arrangement comprises:
a dial having a front side and a back side;
at least a first image of a moon on the front side of the dial,
a rotatable member mounted above the dial, the rotatable member comprising at least a first hand and a second hand, wherein the first hand and the second hand are at least essentially rounded and at least essentially non-transparent;
wherein from a first starting position, a rotation of the rotatable member in a first direction causes the moon image to appear to be waning due to the progressive blocking of the moon image by the first hand and then waxing due to the subsequent progressive unblocking of the moon image by the first hand, and
after the rotatable member rotates in the first direction so that the moon image is at least essentially fully unblocked by the first hand,
the second hand is positioned essentially where the first hand was positioned when the rotatable member was in the first starting position.

2. The wearable device as claimed in claim 1, wherein from the first starting position for the rotatable member, the moon image is fully unblocked by the first hand, and wherein the wearable device comprises a controller for rotating the rotatable member in the first direction so as to cause the moon image to:
(i) appear to be waning due to the progressive blocking of the moon image by the first hand,
(ii) next be at least essentially fully blocked by the first hand thereby providing a moon phase representative of a new moon, and
(iii) then appear to be waxing due to the unblocking of the moon image by the first hand,
wherein the rotatable member rotates in the first direction until the moon image is at least essentially fully unblocked by the first hand.

3. The wearable device as claimed in claim 2, wherein the first direction is a counterclockwise direction.

4. A wearable device comprising a display arrangement for displaying moon phases, wherein the display arrangement comprises:
a dial having a front side and a back side;
at least a first image of a moon on the front side of the dial and a second image of a moon on the front side of the dial, wherein the second moon image is spaced from the first moon image;
a rotatable member mounted above the dial, the rotatable member comprising at least a hand, the first hand being at least essentially rounded and at least essentially non-transparent;
selecting means for selecting whether to display moon phases using the first moon image or the second moon image, wherein in response to the selecting, the controller causes the rotatable member to be positioned in one of a plurality of starting positions,
wherein from a first starting position, a rotation of the rotatable member in a first direction causes the moon images, which are selected to be displayed using the first moon image or the second moon image, to appear to be waning due to the progressive blocking of the selected first or second moon image by the hand and then waxing due to the subsequent progressive unblocking of the selected moon image by the hand;
wherein selecting to display moon phases using the first moon image will display moon phase images consistent with views from the northern hemisphere and selecting to display moon phases using the second moon image will display moon phase images consistent with views from the southern hemisphere.

5. The wearable device as claimed in claim 4, wherein the hand comprises a cover for covering the moon image that is not selected while the rotatable member rotates in the first direction.

6. The wearable device as claimed in claim 5, wherein the rotatable member rotates in the first direction and at a first rate of rotation until the moon image appears to be a new moon, and then prior to the rotatable member rotating so as to cause the moon image to appear to be waxing, the rotatable member rotates in the first or second direction at a rate faster than the first rate of rotation to position the rotatable member for the progressive unblocking of the moon image by the hand.

7. The wearable device as claimed in claim 4, wherein the first moon image is located about a top half of the dial and wherein the second moon image is located about a bottom half of the dial.

8. A wearable device comprising a display arrangement for displaying moon phases, wherein the display arrangement comprises:
a dial having a front side and a back side;
at least a first image of a moon on the front side of the dial and a second image of a moon on the front side of the dial;
a rotatable member mounted above the dial, the rotatable member comprising at least a first hand and a second hand, wherein the first and second hands are each at least essentially rounded and at least essentially non-transparent;
wherein;
from the first starting position, a rotation of the rotatable member in a first direction causes the first moon image to appear to be waning due to the progressive blocking of the first moon image by the first hand simultaneously with causing the second moon image to appear to be waning due to the identical progressive blocking of the second moon image by the second hand, and thereafter,
further causing the first moon image to appear to be waxing due to the subsequent progressive unblocking of the first moon image by the first hand simultaneously with causing the second moon image to appear to be waxing due to the identical progressive unblocking of the second moon image by the second hand;
whereby the first moon images are representative of moon phases viewed from the northern hemisphere and the second moon images are representative of moon phases viewed from the southern hemisphere.

9. The wearable device as claimed in claim 8, wherein the first moon image is located about a top half of the dial and wherein the second moon image is located about a bottom half of the dial.

10. The wearable device as claimed in claim 1, wherein from a second starting position, a rotation of the rotatable member in a direction opposite the first direction causes the moon image to appear to be waning due to the progressive blocking of the moon image by the first hand and then waxing due to the subsequent progressive unblocking of the moon image by the first hand.

11. The wearable device as claimed in claim 10, wherein the first direction is the counterclockwise direction and the second direction is the clockwise direction.

12. The wearable device as claimed in claim 4, wherein from a second starting position, a rotation of the rotatable member in a direction opposite the first direction causes the moon image to appear to be waning due to the progressive blocking of the moon image by the first hand and then waxing due to the subsequent progressive unblocking of the moon image by the first hand.

13. The wearable device as claimed in claim 12, wherein the first direction is the counterclockwise direction and the second direction is the clockwise direction.

14. The wearable device as claimed in claim 8, wherein from a second starting position, a rotation of the rotatable member in a direction opposite the first direction causes the moon image to appear to be waning due to the progressive blocking of the moon image by the first hand and then waxing due to the subsequent progressive unblocking of the moon image by the first hand.

15. The wearable device as claimed in claim 14, wherein the first direction is the counterclockwise direction and the second direction is the clockwise direction.

16. A wearable device comprising a display arrangement for displaying moon phases, wherein the display arrangement comprises:
a dial having a front side and a back side;
at least a first image of a moon on the front side of the dial,
a rotatable member mounted above the dial, the rotatable member comprising at least a first hand, the first hand being at least essentially rounded and at least essentially non-transparent;
wherein from a first starting position, a rotation of the rotatable member in a first direction and at a first rate of rotation causes the moon image to appear to be waning due to the progressive blocking of the moon image by the first hand and then waxing due to the subsequent progressive unblocking of the moon image by the first hand;
wherein from the first starting position for the rotatable member, the moon image is fully unblocked by the first hand, and
wherein the wearable device comprises a controller for operatively causing the rotatable member to rotate in the first direction so as to cause the moon image to (i) appear to be waning due to the progressive blocking of the moon image by the first hand, (ii) next be at least essentially fully blocked by the first hand thereby providing a moon phase representative of a new moon, and (iii) then appear to be waxing due to the unblocking of the moon image by the first hand,
wherein the rotatable member rotates in the first direction until the moon image is at least essentially fully unblocked by the first hand; and
wherein after the rotatable member has rotated in the first direction so that the moon image is at least essentially fully unblocked by the first hand,
the controller causes the rotatable member to continue to rotate in the first direction until the rotatable member is in the first starting position.

17. The wearable device as claimed in claim 16, wherein the controller causes the rotatable member to continue to rotate in the first direction until the rotatable member is in the first starting position at a rate faster than the first rate of rotation.

18. The wearable device as claimed in claim 16, wherein the rotation of the rotatable member to rotate in the direction opposite the first direction is approximately 180°.
